(19) United States
(12) Patent Application Publication
(10) Pub. No.: US 2014/0255675 A1
(43) Pub. Date: Sep. 11, 2014

(54) SELF-ADHESIVE PROTECTION FILM HAVING IMPROVED RELEASE, AND PRODUCT HAVING THE FILM ATTACHED THERETO

(71) Applicant: Korea Institute of Industrial Technology, Cheonan-si, Chungcheongnam-do (KR)

(72) Inventors: Dong Hyun Kim, Gunpo-si (KR); Joon Chul Lee, Hwaseong-si (KR); No Hyung Park, Anyang-si (KR)

(73) Assignee: Korea Institute of Industrial Technology, Cheonan-si, Chungcheongnam-do (KR)

(21) Appl. No.: 14/351,100

(22) PCT Filed: Oct. 17, 2012
(86) PCT No.: PCT/KR2012/008457

§ 371 Date: Apr. 10, 2014

(30) Foreign Application Priority Data
Oct. 18, 2011 (JP) 10-2011-0106596

(51) Int. Cl. C09J 7/02

(52) U.S. Cl. CPC C09J 7/0225
USPC 428/213; 428/354; 428/172

(57) ABSTRACT

The present invention relates to a self-adhesive protection film having improved release properties and a product attached with the same, and in particular, to a multilayered self-adhesive protection film having particularly enhanced release properties by comprising monodisperse beads in a carrier layer or the carrier layer being embo patterned, and to a product attached with the self-adhesive protection film.

### DESCRIPTION

1. Technical Field

The present invention relates to a self-adhesive protection film having improved release properties and a product attached with the same, and in particular, to a multilayered self-adhesive protection film having particularly enhanced release properties by comprising monodisperse beads in a carrier layer or the carrier layer being embo patterned, and to a product attached with the self-adhesive protection film.

2. Background Art

A protection film is known as a protect film, a masking film, a cover film or the like, and a self-adhesive protection film can adhere to a substrate without applying a separate adhesive, which is different from general protection films, since the film itself has adhesive properties.

These protection films are films that protect various components and materials used for IT products and construction materials. The films are applied to construction materials and interior materials as well as IT products such as mobile phones, LCD and LED, home appliances and electronic products, and are used in order to prevent contamination from outside when various components and materials are transferred and stored for a long time.

Recently, as components and materials used for IT products become complicated and miniaturized, demands have been growing from companies for the development of highly efficient protection films having zero defects with no transfer problems that cause defects.

A manufacturing process of existing solvent-type protection films comprises a base film loading (releasing) process, an applying process for applying a prepared coating solution on the film, a drying process for removing residual liquids within the coating solution, an aging process, a cutting process for each product of application, and the like. An adhesive used in the solvent-type adhesive protection film is an acrylic-based type, and a solvent is used when coating is performed. The solvents used at the time comprise toluene, xylene, butyl acetate and the like, and these solvents may cause lightheadedness, headaches and the like to workers due to the toxicity of these solvents. In addition, volatile organic compounds (VOC), which are harmful to the air environment, are produced during the drying process and the like, and therefore, the development of alternative technologies, that is, processes, which address the fundamental issues of these problems, are necessary.

Recently, a solvent-free-type self-adhesive protection film manufacturing process, which does not use a solvent, has been proposed as a technology to replace a solvent-type protection film manufacturing process. This solvent-free-type self-adhesive protection film also has an advantage in that, while a solvent-type protection film has low recyclability due to the adhesive applied on the surface, the solvent-free-type self-adhesive protection film can overcome this low recyclability.

Currently, the necessity and interest in the development of a self-adhesive protection films has greatly increased owing to their advantages described above, however, considering the underdeveloped level of domestic products, efforts by small and medium-sized manufacturing companies for technological development have been insufficient.

Generally, in order to have self-adhesive properties when a protection film is processed using a blown method or a casting method, the protection film needs to be processed as a multilayer in which ethylenevinyl acetate, ethylene acrylic acid, VLDPE and the like, which have self-adhesive properties, are coextruded to a layer adhering to a substrate.

However, existing coextrusion multilayer films, in which a vinyl acetate-based adhesive layer is applied, have disadvantages in that they have inferior adhesive power, heat resistance and the like compared to existing solvent-type adhesive protection films. In addition, there are disadvantages of having a high percentage of defective products due to the occurrence of defects during the film extrusion process, and this results in limited application of the existing coextrusion multilayer film to optical sheet and the like, which require high quality.

A self-adhesive protection film needs to have high adhesive power, and has a minimal rate of change of film properties over an elapsed time in order to strengthen heat resistance. In addition, cutting needs to be easy after the film is adhered to a substrate, no residual materials need to be present in the substrate after the film is peeled off, transparency needs to be provided, and control of mechanical strength such as tensile strength and elongation of a multilayer film needs to be possible.

The inventors have carried out research in view of the above, have prepared a self-adhesive protection film that comprises a carrier layer comprised of a polyolefin-based resin; an intermediate layer comprised of a polyolefin-based resin; and an adhesion layer comprised of a mixture of a polyolefin-based resin and an elastomer resin, wherein the carrier layer comprises monodisperse beads or is embo patterned, have investigated its release properties, adhesive properties, cutting properties and no-residue properties, and have verified that the self-adhesive protection film described above has excellent release properties, adhesive properties, cutting properties and no-residue properties, thereby completing the present invention.

### DISCLOSURE

### Technical Problem

An objective of the present invention is to provide a multilayered self-adhesive protection film having enhanced release properties by comprising monodisperse beads in a carrier layer or the carrier layer being embo patterned.

Another objective of the present invention is to provide a product attached with the multilayered self-adhesive protection film having enhanced release properties.

### Technical Solution

In order to solve the problems described above, the present invention provides a self-adhesive protection film that comprises a carrier layer comprised of a polyolefin-based resin; an intermediate layer comprised of a polyolefin-based resin; and an adhesion layer comprised of a mixture of a 40 to 80% by weight polyolefin-based resin and a 20 to 60% by weight elastomer resin having an epoxy group, a hydroxy group or an amine group, wherein the melting index of the elastomer resin having an epoxy group, a hydroxy group or an amine group, which is comprised in the adhesion layer, ranges from 1 to 12 g/10 minutes, and the density thereof ranges from 0.85 to 1.2 g/cm³, and the carrier layer comprises monodisperse beads or is embo patterned.

The melting index of the elastomer resin having an epoxy group, a hydroxy group or an amine group, which is comprised in the adhesion layer, preferably ranges from 1 to 4 g/10 minutes. In addition, the density of the elastomer resin having an epoxy group, a hydroxy group or an amine group, which is comprised in the adhesion layer, preferably ranges from 0.85 to 0.95 g/cm³.

The term ‘self-adhesive properties’ used in the present invention means properties of a film enabling adhesion to an adhered surface without using any other adhesives, without applying additional pressure or heat, or without using mechanical means such as a thumbtack, a screw, a staple, a nail or a wire.

The term ‘protection film’ used in the present invention means a film that protects an adherend from scratches or protects a surface of the adherend due to being unable to be peeled off by being adhered to the surface to be protected.

In the present invention, the carrier layer is comprised of a polyolefin-based resin.

In the present invention, the polyolefin-based resin of the carrier layer preferably comprises polyethylene having a melting index ranging from 0.5 to 4 g/10 minutes and density ranging from 0.90 to 1.10 g/cm³.

In the present invention, the polyolefin-based resin of the carrier layer may be prepared with a polymerization method using a Ziegler-based catalyst, a chrome-based catalyst, a metallocene-based catalyst or the like, the copolymer may have the form of a random copolymer or a block copolymer, the molecular structure can be any one of an atactic, isotactic or syndiotactic structure, and the polymerization method can be any one of a low pressure method, a medium pressure method or a high pressure method. Additives such as a heat stabilizer, an ultraviolet light absorbent, an antistatic agent or a fluorescent agent can be mixed to this polyolefin-based resin according to well-known methods.

In the self-adhesive protection film of the present invention, the carrier layer comprises monodisperse beads or is embo patterned, and as a result, it has the characteristic of enhanced release strength.

The term ‘monodisperse bead’ used in the present invention means a bead having a uniform size and form.

In the present invention, the pproduct size of the monodisperse bead preferably ranges from 0.5 to 10 μm. If the pproduct size of the monodisperse bead is smaller than the lowest limit or larger than the highest limit, there is a disadvantage in that target level release properties are not exhibited.

In the present invention, the monodisperse bead preferably comprises an acrylic-based homopolymer or copolymer, although not limited thereto.

In the present invention, as the acrylic-based monomer that can be used to polymerize the monodisperse beads comprising the acrylic-based homopolymer or copolymer, methyl(meth)acrylate, ethyl(meth)acrylate, trimethylomethane tetraacrylate, trimethylomethane triacrylate, trimethylobutane triacrylate, glycidyl(meth)acrylate, ethylene glycol diglycidyl methacrylate or the like may be used either alone or as a combination of two types or more.

In the present invention, the monodisperse bead may be readily prepared through a common dispersion polymerization.

In the present invention, after a concentrated masterbatch is made through the compounding of monodisperse beads with a resin and additives of the carrier layer, the resin of the carrier layer and the masterbatch is mixed and kneaded, and extruded, and finally, a film-type carrier layer comprising monodisperse beads may be prepared. The term ‘embo patterning’ used in the present invention means a pattern formed as embossed carving on the surface.

In the present invention, the embo patterning can be introduced to the surface of the carrier layer by transferring an embo patterned roll to the carrier layer when a film is processed.

In the present invention, the embo diameter of the embo patterning preferably ranges from 1 to 1000 μm. If the embo diameter of the embo patterning is smaller than the lowest limit or larger than the highest limit, there is a disadvantage in that target level release properties are not exhibited.

The self-adhesive protection film of the present invention either comprises the monodisperse beads as above in the carrier layer or the carrier layer being embo patterned, and as a result, the release strength was enhanced to 4 g/25 mm or less, and preferably to 1 to 4 g/25 mm. Specifically, in the examples of the present invention, a self-adhesive protection film having a release strength of 1.5 to 3.5 g/25 mm was prepared.

In the present invention, the thickness of the carrier layer preferably ranges from 10 to 20 μm.

If the thickness of the carrier layer is smaller than the lowest limit, there is a disadvantage in that the mechanical strength of the film becomes weak, and if the thickness is larger than the highest limit, there is a disadvantage in that the flexibility of the film decreases.

In the present invention, the intermediate layer is comprised of a polyolefin-based resin.

In the present invention, the polyolefin-based resin of the intermediate layer preferably comprises polyethylene having a melting index ranging from 4 to 8 g/10 minutes and density ranging from 0.90 to 1.10 g/cm³.

In the present invention, the preparation method, the form, and the additives of the polyolefin-based resin of the intermediate layer are the same as those of the polyolefin-based resin of the carrier layer, however, the melting index can be adjusted to have a difference.

In the present invention, the thickness of the intermediate layer preferably ranges from 5 to 15 μm.

If the thickness of the intermediate layer is smaller than the lowest limit, there is a disadvantage in that the mechanical strength of the film becomes weak, and if the thickness is larger than the highest limit, there is a disadvantage in that the flexibility of the film decreases.

In the present invention, the adhesion layer is comprised of a mixture of a 40 to 80% by weight polyolefin-based resin and a 20 to 60% by weight elastomer resin having an epoxy group, a hydroxy group or an amine group. If the mixing ratio of the elastomer resin is higher than the above range, the formation of a film may be difficult, and if the mixing ratio is lower than the above range, reliability may be reduced.

The term ‘elastomer resin’ used in the present invention means a synthetic polymer material having similar properties to rubber, which comprise the property of returning to its original shape when being transformed, that is, being resilient, being durable, being not easily worn out, and being resistant to chemicals. Although having an advantage of high adhesive power, the elastomer resin has had limited application in protection films since self-adhesiveness is difficult due to the difficulty in separating the elastomer resin after it is adhered, and further, applications have been limited since it is difficult to prepare the elastomer resin in a film form due to agglutination.

In the present invention, a mixture obtained by mixing the polyolefin-based resin to the elastomer resin in a proper mixing ratio in order to utilize the high adhesive power of the elastomer resin and to grant the ease of separation and the ease of film formation at the same time is provided as the adhesion layer.

In the present invention, the adhesion layer is more preferably an adhesion layer particularly comprised of a mixture of a 40 to 60% by weight polyolefin-based resin and a 40 to 60% by weight elastomer resin in terms of the ease of film formation and reliability.

In the present invention, the elastomer resin may be selected from the group comprising of an ethylene-based, a styrene-based, a propylene-based, an acrylonitrile-based, a butadiene-based, an acrylic-based, an isoprene-based, a polyurethane-based and a silicone-based elastomer resin, but is not limited thereto.

In the present invention, the elastomer resin preferably has a weight average molecular weight ranging from 500 to 2,000,000. If the weight average molecular weight of the elastomer resin is beyond the above range, there is a disadvantage in that the film process is difficult.

In the examples of the present invention, as the elastomer resin, SG-P3TEA (manufactured by Nagase, manufactured in Japan) was used as an elastomer resin comprising 15% by weight epoxy.

In the present invention, the polyolefin-based resin used in the adhesion layer is the same as that described in the intermediate layer.

In the present invention, the thickness of the adhesion layer preferably ranges from 10 to 20 μm.

If the thickness of the adhesion layer is smaller than the lowest limit, there is a disadvantage in that the reliability is reduced, and if the thickness is larger than the highest limit, there is a disadvantage in that the manufacturing costs increase.

In the present invention, the thickness ratio of the carrier layer : intermediate layer : adhesion layer is preferably 10 to 20:5 to 15:10 to 20. This is for controlling the durability and the mechanical strength of the protection film to be superior.

In the present invention, the multilayered self-adhesive protection film can be adhered to the surface of plastics, metals or glasses, although it is not limited thereto.

The self-adhesive protection film according to the present invention may be obtained by common inflation methods and/or casting methods.

The inventors have prepared a multilayered self-adhesive protection film as above in which the carrier layer comprises monodisperse beads or is embo patterned, have investigated its release properties, adhesive properties, cutting properties and no-residue properties, and have verified that the self-adhesive protection film has excellent release properties, adhesive properties, cutting properties and no-residue properties.

In addition, the present invention provides a product attached with the multilayered self-adhesive protection film described above in which the carrier layer comprises monodisperse beads or is embo patterned.

In the present invention, the product may comprise an optical sheet, a mobile phone, a computer monitor, a television, a dry film photoresist (DFR), a plastic board building panel display device, a membrane touch panel, a carrier film or an entry sheet of flexible printed circuit board, a construction material, precision glass, an interior material of automobile, a children's toy, a kitchen container, or a heating and cooling apparatus, but is not limited thereto.

### Advantageous Effects

In the present invention, a self-adhesive protection film is provided, which comprises a carrier layer comprised of a polyolefin-based resin; an intermediate layer comprised of a polyolefin-based resin; and an adhesion layer comprised of a mixture of a polyolefin-based resin and an elastomer resin, wherein the carrier layer comprises monodisperse beads or is embo patterned, and as a result, a self-adhesive protection film having excellent adhesive properties, cutting properties and no-residue properties and having particularly enhanced release properties can be provided. Applying this film to home appliances, electronic products construction materials, and the like can hugely contribute to growth of production in various components and materials industries.

### Mode for Disclosure

Hereinafter, the present invention is described in detail with reference to the following examples. However, these examples are for illustrative purposes only, and the scope of the present invention is not limited thereto.

### EXAMPLES 1-6 AND COMPARATIVE EXAMPLES 1-2

### Preparation of Self-Adhesive Protection Film

The self-adhesive protection film was prepared using the following resins with the mixing ratio and the thickness ratio of each layer shown in Table 1.

Specifically, the resin of each layer in a pellet state, which was obtained through the dry blending or melt blending of the resin in a pellet state, was weighed and introduced to each hopper, and then was melt extruded under the extrusion conditions of 250° C. for the carrier layer and the intermediate layer, and 150° C. for the adhesion layer through two common single screw extruders or twin screw extruders (Jenn Chong Plastics Machinery Works Co. Ltd., JC-LH series). In order to introduce release properties to the carrier layer of the laminated film through a die, monodisperse beads were introduced to the carrier layer through compounding, or an embo patterned roll was transferred through a die before the laminated surface was cooled, and then a multilayered self-adhesive surface protection film having a thickness ranging from 30 to 50 μm was finally obtained by cooling the whole laminated film using an air-cooling method or a water-cooling method. At this time, the self-adhesive protection film was prepared in a clean room of class 1,000 to 10,000 range.

### Information on Materials

Resin A: low density polyethylene having a melting index of 1.2 g/10 minutes and density of 0.93 g/cm³

Resin B: high density polyethylene having a melting index of 0.9 g/10 minutes and density of 0.96 g/cm³

Resin C: medium density polyethylene having a melting index of 5.2 g/10 minutes and density of 0.94 g/cm³

Resin D: SG-P3TEA, an elastomer resin comprising 15% by weight epoxy (manufactured by Nagase, manufactured in Japan)

Bead (2): pproduct diameter 2 μm, PMMA (polymethylmethacrylate) resin composition

Bead (4): pproduct diameter 4 μm, PMMA (polymethylmethacrylate) resin composition

Bead (6): pproduct diameter 6 μm, PMMA (polymethylmethacrylate) resin composition

Bead (8): pproduct diameter 10 μm, PMMA (polymethylmethacrylate) resin composition

Embo (50 μm): embo patterning having an embo diameter of 50 μm

Embo (200 μm): embo patterning having an embo diameter of 200 μm

TABLE 1

| | Resin Composition | | | Layer Thickness Ratio (μm) | | |
|---|---|---|---|---|---|---|
| | Carrier | Intermediate | Adhesion | Carrier | Intermediate | Adhesion |
| Category | Layer | Layer | Layer | Layer | Layer | Layer |
| Example 1 | Bead (2)/ | Resin C | Resin C/ | 15 | 10 | 15 |
| | Resin A | | Resin D | | | |
| | | | (40/60) | | | |
| Example 2 | Bead (4)/ | Resin C | Resin C/ | 15 | 10 | 15 |
| | Resin A | | Resin D | | | |
| | | | (40/60) | | | |
| Example 3 | Bead (6)/ | Resin C | Resin C/ | 15 | 10 | 15 |
| | Resin A | | Resin D | | | |
| | | | (40/60) | | | |
| Example 4 | Bead (8)/ | Resin C | Resin C/ | 15 | 10 | 15 |
| | Resin A | | Resin D | | | |
| | | | (40/60) | | | |
| Example 5 | Embo (50 μm)/ | Resin C | Resin C/ | 15 | 10 | 15 |
| | Resin A | | Resin D | | | |
| | | | (40/60) | | | |
| Example 6 | Embo | Resin C | Resin C/ | 15 | 10 | 15 |
| | (200 μm)/ | | Resin D | | | |
| | Resin A | | (40/60) | | | |
| Comparative | Resin A | Resin C | Resin C/ | 20 | 15 | 15 |
| Example 1 | | | Resin D | | | |
| | | | (40/60) | | | |
| Comparative | Resin B | Resin C | Resin C/ | 20 | 15 | 15 |
| Example 2 | | | Resin D | | | |
| | | | (40/60) | | | |

### EXPERIMENTAL EXAMPLE 1

### Investigation of Physical Properties of Self-Adhesive Protection Film of Present Invention

The physical properties of the self-adhesive protection film of the present invention were measured as follows.

For release properties and adhesive properties, the adhesion layer and polycarbonate employed as the substrate layer were adhered using a 3 Kg roller at room temperature. After 30 minutes, the release properties and the adhesive properties (g/25 mm) were measured as peel strength between the film and the substrate by pulling with a speed of 300 mm/minute using a universal tester.

For the change rate of adhesive properties over an elapsed time, the change rate was observed by a 180° peel test with a width of 25 mm and a peel rate of 300 mm/minute after the film was left unattended in an oven at 50° C. for two days.

For cutting properties, the cutting properties of the protection film was evaluated by comprehensively judging the ease of cutting, whether the edge was stretched, whether powder was generated and the like, while a film specimen was adhered to the substrate and cut into certain sizes (∘ favorable, Δ average, x poor).

For residue properties, the film was peeled off, then the materials remaining in the substrate were evaluated with the naked eyes in two steps by identifying whether the residues present or not (∘ present, x not present).

The measurement results are shown in the following Table 2.

TABLE 2

| | | | the change rate | | |
|---|---|---|---|---|---|
| | | | of adhesive | | |
| | Release | Adhesive | properties over | Cutting | Residue |
| | Strength | Strength | an elapsed | Proper- | Proper- |
| Category | (g/25 mm) | (g/25 mm) | time (%) | ties | ties |
| Example 1 | 3.1 | 50 | 14 | ∘ | x |
| Example 2 | 3.5 | 49 | 13 | ∘ | x |
| Example 3 | 1.8 | 50 | 13 | ∘ | x |
| Example 4 | 1.5 | 48 | 15 | ∘ | x |
| Example 5 | 1.5 | 49 | 13 | ∘ | x |
| Example 6 | 2.0 | 49 | 15 | ∘ | x |
| Comparative | 5.0 | 50 | 14 | ∘ | x |
| Example 1 | | | | | |
| Comparative | 5.0 | 48 | 13 | ∘ | x |
| Example 2 | | | | | |

As is seen from Table 2, it was verified that the self-adhesive protection film of the examples had significantly enhanced release properties compared to the protection film of comparative examples, and in addition to this, it was also verified that the self-adhesive protection film of the examples had excellent properties comprising adhesive properties, a change rate over an elapsed time, cutting properties and no-residue properties. Therefore, from the results described above, it was verified that the self-adhesive protection film of the present invention had particularly excellent release properties, and had excellent adhesive properties, cutting properties and no-residue properties.

1. A self-adhesive protection film comprising:
a carrier layer comprised of a polyolefin-based resin;
an intermediate layer comprised of a polyolefin-based resin; and
an adhesion layer comprised of a mixture of a 40 to 80% by weight polyolefin-based resin and a 20 to 60% by weight elastomer resin having an epoxy group, a hydroxy group or an amine group,
wherein a melting index of the elastomer resin having an epoxy group, a hydroxy group or an amine group, which is comprised in the adhesion layer, ranges from 1 to 12 g/10 minutes, and density thereof ranges from 0.85 to 1.2 g/cm³; and
wherein the carrier layer comprises monodisperse beads or is embo patterned.

2. The self-adhesive protection film of claim 1, wherein the polyolefin-based resin of the carrier layer comprises polyethylene having a melting index ranging from 0.5 to 4 g/10 minutes and density ranging from 0.90 to 1.10 g/cm³.

3. The self-adhesive protection film of claim 1, wherein the monodisperse bead comprises an acrylic-based homopolymer or a copolymer.

4. The self-adhesive protection film of claim 1, wherein an embo diameter of the embo patterning ranges from 1 to 1000 μm.

5. The self-adhesive protection film of claim 1, wherein a release strength of the self-adhesive protection film ranges from 1 to 4 g/25 mm.

6. The self-adhesive protection film of claim 1, wherein the polyolefin-based resin of the intermediate layer comprises polyethylene having a melting index ranging from 4 to 8 g/10 minutes and density ranging from 0.90 to 1.10 g/cm³.

7. The self-adhesive protection film of claim 1, wherein the adhesion layer is comprised of a mixture of a 40 to 60% by weight polyolefin-based resin and a 40 to 60% by weight elastomer resin having an epoxy group, a hydroxy group or an amine group.

8. The self-adhesive protection film of claim 7, wherein the polyolefin-based resin of the adhesion layer comprises polyethylene having a melting index ranging from 4 to 8 g/10 minutes and density ranging from 0.90 to 1.10 g/cm³.

9. The self-adhesive protection film of claim 1, wherein the elastomer resin is selected from the group consisting of an ethylene-based, a styrene-based, a propylene-based, an acrylonitrile-based, a butadiene-based, an acrylic-based, an isoprene-based, a polyurethane-based and a silicone-based elastomer resin.

10. The self-adhesive protection film of claim 9, wherein the elastomer resin has a weight average molecular weight ranging from 500 to 2,000,000.

11. The self-adhesive protection film of claim 1, wherein a thickness ratio of the carrier layer:intermediate layer:adhesion layer is 10 to 20:5 to 15:10 to 20.

12. The self-adhesive protection film of claim 1, which is adhered to a surface of plastics, metals or glass.

13. A product attached with a self-adhesive protection film comprising:
a carrier layer comprised of a polyolefin-based resin;
an intermediate layer comprised of a polyolefin-based resin; and
an adhesion layer comprised of a mixture of a 40 to 80% by weight polyolefin-based resin and a 20 to 60% by weight elastomer resin having an epoxy group, a hydroxy group or an amine group,
wherein a melting index of the elastomer resin having an epoxy group, a hydroxy group or an amine group, which is comprised in the adhesion layer, ranges from 1 to 12 g/10 minutes, and density thereof ranges from 0.85 to 1.2 g/cm³; and
wherein the carrier layer comprises monodisperse beads or is embo patterned.

14. The product of claim 13, which comprises an optical sheet, a mobile phone, a computer monitor, a television, a dry film photoresist (DFR), a plastic board building panel display device, a membrane touch panel, a carrier film or an entry sheet of flexible printed circuit board, a construction material, precision glass, an interior material of automobile, a children's toy, a kitchen container, or a heating and cooling apparatus.

15. The product of claim 13, wherein the polyolefin-based resin of the carrier layer comprises polyethylene having a melting index ranging from 0.5 to 4 g/10 minutes and density ranging from 0.90 to 1.10 g/cm³.

16. The product of claim 13, wherein the monodisperse bead comprises an acrylic-based homopolymer or a copolymer.

17. The product of claim 13, wherein an embo diameter of the embo patterning ranges from 1 to 1000 μm.

18. The product of claim 13, wherein a release strength of the self-adhesive protection film ranges from 1 to 4 g/25 mm.

19. The product of claim 13, wherein the polyolefin-based resin of the intermediate layer comprises polyethylene having a melting index ranging from 4 to 8 g/10 minutes and density ranging from 0.90 to 1.10 g/cm³.

20. The product of claim 13, wherein the adhesion layer is comprised of a mixture of a 40 to 60% by weight polyolefin-based resin and a 40 to 60% by weight elastomer resin having an epoxy group, a hydroxy group or an amine group.
